(19) United States
(12) Patent Application Publication
(10) Pub. No.: US 2026/0247064 A1
(43) Pub. Date: Aug. 20, 2026

(54) HANDHELD WIRELESS OUTDOOR SPEAKER

(71) Applicant: Turtlebox Audio LLC, Houston, TX (US)

(72) Inventors: Evan Maverick James QUIROS, Houston, TX (US); Reagan Crockett FINCHER, Houston, TX (US); Jonathan Michael MCKENZIE, Houston, TX (US); William Douglas BRADLEY, Houston, TX (US); Jeffrey Dan BEZNER, Katy, TX (US); Joel Ryan HIERHOLZER, Altamonte Springs, FL (US); Zachary Marshall ETTER, Battle Ground, WA (US); Brian Kelly RADGOWSKI, Tryon, NC (US); Vic Omer RICHARDSON, Kirkland, WA (US)

(21) Appl. No.: 19/435,352

(22) Filed: Dec. 29, 2025

Related U.S. Application Data
(60) Provisional application No. 63/760,364, filed on Feb. 19, 2025.

(51) Int. Cl. H04R 1/28; G06F 3/16; H04R 1/02; H04R 3/00; H04R 7/12

(52) U.S. Cl. CPC H04R 1/2834; G06F 3/162; H04R 1/023; H04R 1/025; H04R 1/026; H04R 1/2811; H04R 3/00; H04R 7/12; H04R 2420/07

(57) ABSTRACT

The disclosed principles provide a portable wireless speaker designed and constructed for outdoor use. In one embodiment, a speaker in accordance with the disclosed principles comprises an inner structure defining a watertight hollow cavity within the inner structure. In addition, such a speaker as disclosed herein comprises at least two speaker drivers mounted at least partially within the hollow cavity, each speaker driver facing a first direction and having parallel centerlines. Such a speaker may further comprise at least one bass diaphragm mounted at least partially within the hollow cavity, and having a centerline between the centerlines of the at least two speaker drivers, the bass diaphragm facing a second direction oriented substantially 180 degrees from the first direction such that low-end frequency sounds waves emanating from a rear of the at least two speaker drivers are permitted exit from the hollow cavity via the bass diaphragm.

### RELATED APPLICATIONS

The present disclosure claims priority to U.S. Provisional Patent Application Ser. No. 63/760,364, filed Feb. 19, 2025, the entirety of which is incorporated herein by reference for all purposes.

### TECHNICAL FIELD

The present disclosure is generally related to the field of portable wireless speakers, and more particularly to novel portable wireless waterproof outdoor speaker and methods of manufacture thereof.

### BACKGROUND

With the advent of portable devices, such as smart phones, capable of storing large amounts of music, the desire for portable speakers that can produce quality sound reproduction has continued to increase. This has led to the proliferation of wireless speakers, especially those powered by long-life batteries, such as lithium-ion batteries, and capable of wireless connection to music sources, such as through Bluetooth technology. Along with desired portability of such wireless speakers, a continued desired for a decrease in speaker size exists. However, regardless of portability, speaker size it typically proportional to their sound quality. As a result, as portable wireless speakers continue to shrink in size in order to increase their portability, sound quality typically suffers.

Furthermore, along with the portability of speakers comes a desire to employ those portable speakers in outdoor environments. Thus, the use of speakers in outdoor environments creates new concerns of damage caused by water/moisture, as well as dust and other contaminants present in typical outdoor environments. Even full water resistance of portable speakers is becoming more desirable to accommodate use in boats, pools, and other predominantly water-based environments where direct exposure to water is a constant possibility. However, just as the shrinking size of portable speakers directly impacts sound quality, so too does the reinforcement of portable speaker construction against the elements. The more protected the portable speakers become against water and other potential damages elements, typically the worse the sound quality becomes.

Accordingly, what is needed in the art is a portable wireless speaker and related methods of manufacture that are small enough to be portable within just about any environment and be fortified against the elements, yet do not suffer from the deficiencies in sound quality found with conventional portable speaker designs. The disclosed principles provide such unique portable wireless speakers and related methods of manufacture thereof.

### SUMMARY

To overcome the deficiencies of the prior art, the disclosed principles provide a portable wireless speaker designed and constructed for outdoor use. In one embodiment, a speaker in accordance with the disclosed principles comprises an inner structure defining a watertight hollow cavity within the inner structure. In addition, such a speaker as disclosed herein comprises two or more speaker drivers mounted at least partially within the hollow cavity, each speaker driver facing a first direction and having parallel centerlines. Such a speaker may further comprise at least one bass diaphragm mounted at least partially within the hollow cavity, and having a centerline substantially equally spaced between the centerlines of the two or more loudspeakers, the bass diaphragm facing a second direction oriented substantially 180 degrees from the first direction such that low-end frequency sounds waves emanating from a rear of the loudspeakers are permitted exit from the hollow cavity via the bass diaphragm. Exemplary speakers as disclosed herein may further comprise a plurality of control buttons mounted at least partially within the hollow cavity for controlling corresponding operations of the speaker, and a rechargeable battery providing power to components of the speaker. Moreover, such exemplary speakers may comprise one or more circuit boards mounted within the hollow cavity and powered by the battery, the one or more circuit boards configured to drive the two or more loudspeakers and to receive control inputs via the plurality of control buttons.

### BRIEF DESCRIPTION OF THE DRAWINGS

The novel features believed to be characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawing, in which:

FIG. 1 illustrates a plan view of one embodiment of an outdoor portable wireless speaker designed and constructed in accordance with the disclosed principles;

FIG. 2 illustrates another view of the speaker according to the disclosed principles illustrated in FIG. 1;

FIG. 3 illustrates another view of the backside and bottom of the speaker according to the disclosed principles illustrated in FIGS. 1 and 2 with the backside cover removed;

FIG. 4 illustrates a view of the front and top sides of the speaker according to the disclosed principles illustrated in FIGS. 1-3 with the front side cover removed;

FIG. 5 illustrates a view of the interior of the speaker according to the disclosed principles illustrated in FIGS. 1-4; and

FIG. 6 illustrates a perspective bottom view of the speaker illustrated in FIGS. 1-5.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention described herein are contemplated as would normally occur to one skilled in the art to which the invention relates. Although multiple embodiments are shown and discussed in great detail, it will be apparent to those skilled in the relevant art that some features that are not relevant to the present invention may not be shown for the sake of clarity.

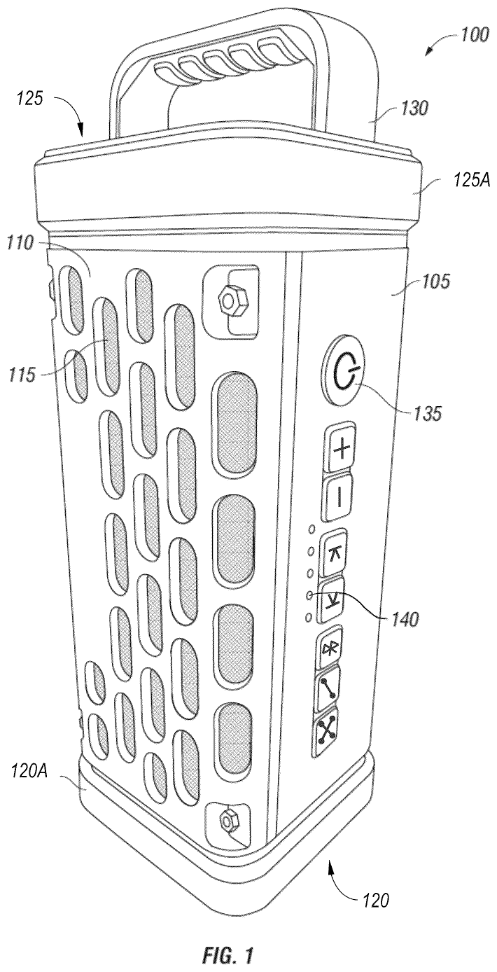

Referring initially to FIG. 1, illustrated is a plan view of one embodiment of an outdoor portable wireless speaker designed and constructed in accordance with the disclosed principles. The speaker 100 includes, in this embodiment, four sides; however, any number of sides may also be provided while maintaining the advantages disclosed herein. A side/control panel 105 can be seen as well as a front panel 110, wherein the front panel 110 is shown secured to an inner structure (not illustrated) with removable fasteners. These fasteners may be provided as screws, rivets, clips, or any other advantageous type of fastener capable of securing the front panel 110 to the inner structure.

Visible through the front panel 110 is an underlying speaker grate or grille 115, which in some embodiments may be affixed to the interior surface of the front panel 110. Apertures may be formed across the surface of the front panel, to permit acoustics generated by the speaker 100 to be emitted outside of the speaker. The speaker grille 115 may be constructed of a durable material, such as plastic or metal, and itself includes numerous apertures across its surface so as to permit acoustic waves generated from within the speaker 100 to be emitted externally. As such, the front panel 110 and the grille 115 may be seen as two grilles positioned together, one providing impact protection or resistance and the other providing protection from small debris, etc. from reaching the speaker drivers.

Also included in this embodiment is a base 120 and a top 125 located at opposite ends of the speaker's body. The base 120 and top 125 may both include bumpers 120A, 125A, respectively, that are affixed to corresponding, opposing ends of the inner structure mentioned above. Affixed to and extending from the top 125 is a handle 130 for grasping the speaker 100. In advantageous embodiments, the base 120, top 125, and handle 130 may all be formed at least partially from an impact resistant material so as to resist damage to the speaker 100 should it be dropped.

In many embodiments, this material comprising the base bumper 120A, top bumper 125A, and exterior of the handle 130 may be a soft, tacky material, such as rubber or a similar material, which promotes a non-slip surface to both grasp the speaker 100 and when the speaker 100 is placed on a surface. In some specific embodiments, the soft, tacky base bumper 120A and top bumper 125A may be removably from the impact resistant material comprising the base 120 and top 125, but be formed with the shape that grasps and securely holds the base bumper 120A and top bumper 125A onto the base 120 and top 125, respectively. Such separation of the base bumper 120A and top bumper 125A and the impact resistant material comprising the base 120 and top 125, permits replacement of the base bumper 120A and/or top bumper 125A should it become damaged, lose its tackiness, begin to deteriorate, to select any of a number of desired colors, or for any other desired reason. In some embodiments, the handle 130 is also removably attached to, and thus detachable from, the top 125 of the speaker 100. Such detachability permits not only replacement if the handle 130 damaged but also the selection of different colored handles 130, as desired.

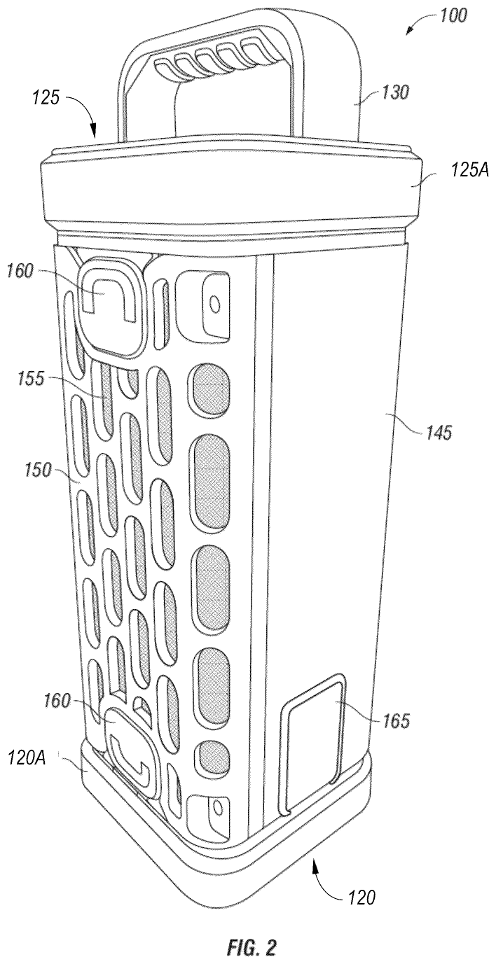

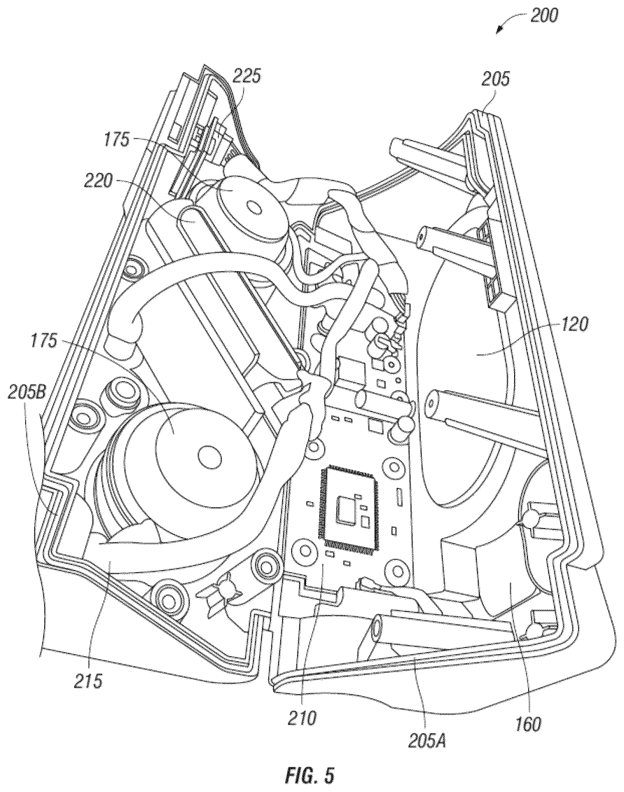

The use of a soft, resilient and tacky material for the base bumper 120A and top bumper 125A (and exterior of the handle 130) is far beyond a mere design or cosmetic choice. The use of such material provides high impact durability should the speaker 100 be dropped, where the resiliency of the soft material permits a high level of bounce-back when either impact a hard surface. Additionally, the width of both the base bumper 120A and top bumper 125A when measured from the front panel 110 to the back panel 150 is specifically selected such that the sides of these bumpers 120A, 125A along the back panel 150 of the speaker 100 extend just slightly (i.e., approximately 0.5 mm-1.0 mm) beyond how far the magnetic mounts 160 (discussed in further detail below with reference to FIG. 2) extend outwardly. This specific size is chosen so that when the speaker 100 is attached to a flat surface using the magnetic mounts 160, these sides of the base bumper 120A and top bumper 125A are slightly compressed, but not enough to push the magnetic mounts 160 free of the mounting surface. This slight compression of the base bumper 120A and top bumper 125A provides vibration dampening (i.e., preventing vibrations of the speaker's hard surfaces against the mounting surface) when sound is output from the speaker. This slight compression when using the magnetic mounts 160 also prevents sliding of the speaker 100. Specifically, if the speaker 100 is magnetically mounted onto a surface that is moving, such as the frame of a vehicle like a golf cart, the tackiness of the base bumper 120A and top bumper 125A being slightly compressed onto the surface grips the surface and thus prevents sliding of the speaker 100 during bumps or just general motion. Still further, the resiliency of the material of the base bumper 120A and top bumper 125A, along with formed/tight fit of the bumpers 120A, 125A onto the top 120 and base 125, respectively, help hold the speaker's “clamshell” housing together (illustrated and described with reference to FIG. 5).

Visible on the control panel 105 is a plurality of buttons 135. In this embodiment, the buttons 135 comprise a power button, which may also function as a start and pause button for any media being played on the speaker 100, as well as previous and next track buttons, volume buttons, and connectivity buttons, such as for use in initiating a Bluetooth connection between the speaker 100 and a user's media player such as their mobile phone. Also visible on the top panel are illuminating lights 140 that may indicate the current battery life of the speaker 100. Advantageously, the buttons 135 and battery indicator lights 140 may include a rubber or other waterproof cover on each of them in order to protect the interior components from water and other elements the speaker 100 may encounter.

Turning now to FIG. 2, illustrated is another view of the speaker 100 illustrated in FIG. 1. From this view of the speaker 100 the base 120, top 125, and handle 130 may all still be seen. However, this view illustrates a side/charge port panel 145 as well as a backside cover 150. The backside cover 150, like the front cover 110, may include a plurality of apertures formed across it to permit acoustic waves to pass from inside the speaker 100 externally. Also as before, a backside speaker grille 155 may be affixed to an interior surface of the backside cover 150. This speaker grille 155 may also again include apertures to permit the pass through of acoustic waves generated from within the speaker 100. As with the front cover 110, this backside cover 150 may also be secured to the inner structure (not illustrated) of the speaker 110 with removable fasteners.

Also illustrated on the backside of the speaker 100 are a pair of magnetic mounts 160. These magnetic mounts 160 may be used to temporarily affix the speaker 100 to a metal surface during use or storage. In advantageous embodiments. The speaker mounts 160 have enough magnetic attraction to not only hold the speaker against the metal surface on which it is mounted, but also strong enough to resist bumps and other movements and vibrations that might otherwise knock the speaker 100 loose from its magnetic attachment to the surface. In some embodiments the magnetic speaker mounts 160 collectively have a magnetic field multiple orders of magnitude greater than an overall weight of the speaker 100. For example, the magnetic speaker mounts 160 collectively have a magnetic field at least four times greater than an overall weight of the speaker 100. Additionally, these magnetic mounts 160 may also include a rubber or other ceiling surface on their exterior, which again prevent water and other ambient elements from entering the interior of the speaker 100.

Illustrated on the charge port panel 145 is a charging port cover 165. This charging port cover 165 houses the charging port for the speaker 100, which may be any type of advantageous charging port, such as USB-A, USB-C, USB mini, USB micro, or any other type of low voltage electrical charging point either now existing or later developed. The charging port cover 165 may advantageously be constructed of a waterproof material, such as rubber, such that a seal between the charging port cover 165 and the charge port panel 145 prevents water and other contaminants from entering the interior of the speaker 100. In some embodiments, the seal is a hermetic seal. In some embodiments, the charging port cover 165 may be flexible such that a user may lift and bend it in order to access the charging port, while in other embodiments the charging port may be hinged and rigid such that a user opens the cover 165 by lifting one end of the cover 165 such that it pivots on such a hinge. Of course, any other type of removable design and structure for the charging port cover 165 may also be included.

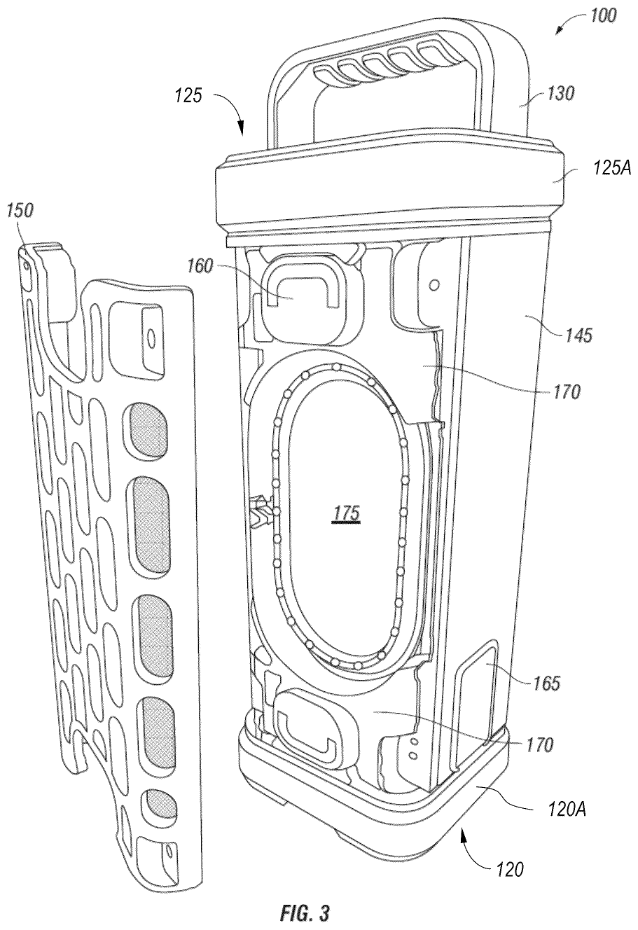

Looking now at FIG. 3, illustrated is another view of the backside and bottom of the speaker 100 illustrated in FIGS. 1 and 2 with the backside cover 150 removed. With the backside cover 150 removed from the speaker 100, the backside of the inner structure 170 can be seen. The inner structure provides the overall structural rigidity of the speaker 100, on which the base 120, top 125, and front and back covers 110, 150, can be mounted. The backside inner structure 170 specifically provides structural support for the backside speaker cover 150, as well as the magnetic mounts 160. Notably, the sealing material formed over and around the magnetic mounts is sealed to or through the backside inner structure 170 so as to provide the sealing against water or other contaminants discussed above. In some embodiments, the seal is a hermetic seal.

An aperture formed through the backside inner structure 170 and accessing the interior of the speaker 100 holds a base or low end speaker diaphragm 175. This base speaker diaphragm 175 is also sealed against the backside inner structure 170 (either on the exterior or interior, or both) so as to prevent water or any other contaminants from entering the interior of the speaker 100. Also, the speaker diaphragm 175 is constructed from materials sufficient to withstand water penetration, and is mounted to the inner structure with a seal sufficient to prevent water or other contaminants from reaching the interior of the speaker 100. In some embodiments, the seal is a hermetic seal. Unlike conventional portable speakers, which either include no low end or base speaker at all or include merely a base vent hole to permit low end acoustic waves to exit the interior of the speaker, a speaker constructed in accordance with the disclosed principles includes an actual low end or base speaker diaphragm 175. Such a construction not only allows low end acoustic waves to exit the interior of the speaker 100, but also provides a barrier against water or contaminants entering the interior of the speaker 100. In some embodiments, a complete base loudspeaker, with both a diaphragm as illustrated and a driver, may be included. In other embodiments, the low frequency acoustic waves are generated in the interior of the speaker 100, using the hollow cavity in the interior of the speaker 100 to reverberate the low frequency acoustic waves before exiting the speaker 100 via the diaphragm 175.

Additionally, the positioning of the bass speaker diaphragm 175 is purposefully located below an exterior surface of the backside inner structure 170. This positioning of the bass speaker diaphragm 175 not only provides structural support for the opposing ends of the backside cover 150, but also protects the bass speaker diaphragm 175 from being contacted by a force pushing inwardly on the backside cover 150. This combination of structural components results in a rigid speaker 100 capable of not only resisting severe impacts to the base 120 and top 125, but also resisting severe impacts to the backside cover 150 of the speaker 100. Such lateral impacts would simply be against the portions of the backside inner structure 170 supporting the backside cover 150, or would cause some inward flexing of the backside cover 150 over the diaphragm 175, but not enough to reach and thereby damage the bass speaker diaphragm 175.

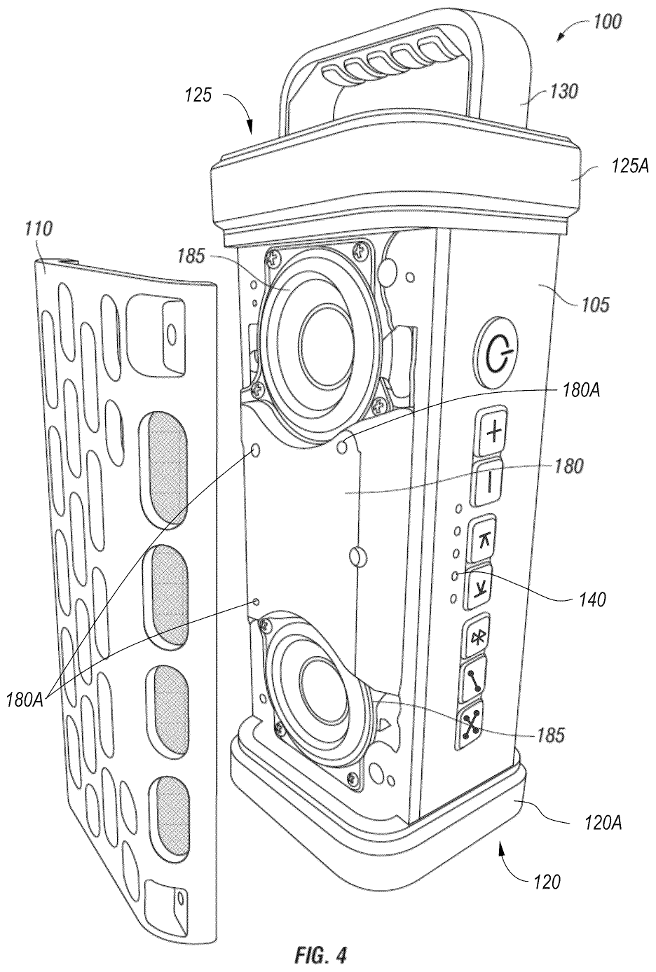

Turning now to FIG. 4, illustrated is a view of the front and top sides of the speaker illustrated in FIGS. 1-3 with the front side cover 110 removed. With the front cover 110 removed from the speaker 100, the frontside of the inner structure 180 can now be seen. As mentioned above, the inner structure provides the overall structural rigidity of the speaker 100, on which the base 120, top 125, and front and back covers 110, 150, are be mounted. The frontside inner structure 180 specifically provides structural support for the front speaker cover 110.

Mounted to the front side inner structure 180 are high frequency range and/or mid-range loudspeakers 185. As “loudspeakers”, each of the speakers 185 comprise a driver having a voice coil for converting incoming electrical audio signals into acoustic signals/waves, as well as a cone comprising a diaphragm and suspension structure for outputting acoustic signals/wave as sounds. In some embodiments, both front-facing speakers 185 may be high-range speakers, both speakers may be mid-range speakers, both speakers may be full-range speakers, or one speaker may be a high-range speaker while the other is a mid-range speaker. The speakers 185 are constructed from materials sufficient to withstand water penetration, and are mounted to the inner structure with a seal between the flange of the speakers 185 and the mounting surface of the inner structure to prevent water or other contaminants from reaching the interior of the speaker 100. In some embodiments, the seal is a hermetic seal.

Additionally, the positioning of these front-facing speakers 185 is purposefully located below an exterior surface of the frontside inner structure 180. This positioning of the speakers 185 not only provides structural support for the central portion of the frontside cover 110, but also protects the speakers 185 from being contacted by a force pushing inwardly on the frontside cover 110. This combination of structural components results in a rigid speaker 100 capable of resisting severe impacts to the frontside cover 110 of the speaker 100. Such lateral impacts would simply be against the central portion of the frontside inner structure 180 supporting the frontside cover 110, or would cause some inward flexing of the frontside cover 110 above the speakers 185, but not enough to reach and thereby damage the speakers 185.

Important in the construction of a speaker 100 in accordance with the disclosed principles is 180 degree opposing positioning of the frontside speakers 185 and the bass speaker diaphragm 175, with a hollow cavity within the inner structure of the speaker 100 permitting reverberation of the acoustic waves generated by the speakers 185 (and if a bass speaker driver is included with the diaphragm 175). The role of the enclosure and cavity of a typical speaker is to prevent sound waves emanating from the back of a speaker driver, such as the frontside speakers 185, from interfering destructively with the sound waves emanating from the front of the speaker driver. A sealed enclosure having a hollow cavity like that of a speaker 100 as disclosed herein prevents transmission of the sound emitted from the rear of the frontside speakers 185 by confining the sound in a rigid and airtight box. However, a rigid enclosure of the disclosed type reflects sound internally, which can then be transmitted back through the frontside speakers' 185 diaphragms, again resulting in degradation of sound quality.

While other speaker enclosure types alter this rearward sound radiation so it can add constructively to the output from the front of the cone, such as in conventional bass reflex designs employing a forward-facing bass vent, speakers that do this are often used to extend the effective low-frequency response and increase the low-frequency output of the frontside speakers/drivers. Of course, a clear disadvantage of such a bass reflex design is the open vent providing access to the interior of the speaker housing to water or other contaminants. Another disadvantage of a bass reflex design is that the rear interior surface of the speaker enclosure should ideally provide a uniform surface to permit uniform reflection of the rearwardly emitted low frequency sound waves back to the forward-facing vent hole. Thus, if circuitry or other components within the speaker enclosure is positioned between the drivers of the high and/or mid-range speakers and the rear wall of the enclosure, uniform reflection of the low-end sound waves is hindered, again being detrimental to sound quality. Worsening this situation is if the speaker enclosure is routinely accessible by a user for storing items, since the interference to low-end frequency sounds waves intended to reflect off of the rear surface of the enclosure would then randomly be affected/disbursed depending on what items are placed in the enclosure at any given time.

However, in a speaker 100 designed and constructed according to the disclosed principles instead embraces the rearward emanation of low-end frequency sounds waves from the rear of the frontside speakers' 185 drivers by positioning the bass speaker diaphragm 175 at an orientation of 180 degrees from the position of the forward-facing frontside speakers 185. With this opposing alignment, low-end frequencies generated by the frontside speakers 185 and that emanate rearwardly from the drivers of the frontside speakers 185 are permitted to exit the interior cavity of the speaker 100 via the bass diaphragm 175. Moreover, the bass diaphragm 175 may be, in some embodiments, uniquely positioned at a midpoint between the two frontside speakers 185 to permit equal emanation of these low-end frequency sound waves. The mounting locations of the frontside speakers 185 are aligned parallel (with respect to forward or back) so that the acoustic center of each driver is in the same vertical plane. Furthermore, the hollow cavity within the interior of the speaker 100 permits some reverberation of these low-end frequency sound waves as well before exiting the bass diaphragm 175. This construction and orientation of the frontside speakers 185 and the bass diaphragm 175 helps prevent sound quality degradation that would occur if such low-end frequency sounds waves emanating rearwardly from the drivers of the frontside speakers 185 reverberated within the interior of the speaker 100 and predominately exited through the cones of the frontside speakers 185.

Also illustrated in FIG. 4 are “breather” holes 180A formed through the inner structure 180. Such breather holes 180A may be used to connect the sealed interior of the inner structure 180 to the outside environment. The inclusion of such breather holes 180A permits the release of pressure build up from within the inner structure 180 that may occur when acoustic waves are generated and reverberate within the inner structure 180, especially as the amplitude (i.e., volume) of acoustic waves is increased. In advantageous embodiments, the breather holes 180A permit bidirectional airflow, but include a membrane, mesh, or other material that permits airflow through it but prevents water from flowing through it and into the inner structure 180. Although the breather holes 180A in the embodiment of FIG. 4 are positioned in flat the portion of the inner structure 180 between the two drivers 185, in other embodiments the breather hole or holes 180A may be positioned elsewhere on the inner structure 180. Also, a greater or lesser number of breather holes 180A may also be employed, if they are included in a speaker as disclosed herein.

Looking now at FIG. 5, illustrated is a view 200 of the interior of the speaker 100 illustrated in FIGS. 1-4. As illustrated, once the speaker 100 is opened and base 120 removed, the casing 205 in this embodiment is a “clamshell” design comprising the housing of the speaker 100 defines an interior cavity within which several components are held. The edges of the casing 205 may include a channel 205A or other similar structure for holding or contacting a seal 205B. As the two halves of the casing 205 are brought together and tightened with the fasteners mentioned above, the entire interior cavity of the speaker 100 is sealed from water or other contaminants by the channel 205A and seal 205B. In some embodiments, the seal is a hermetic seal. The interior surface of the bass diaphragm 175 is also visible from within the casing 205. As sound waves are generated by the front-facing speakers 175 they reverberate within the hollow interior cavity defined within the casing 205, and the low-end frequency sounds waves can exit the speaker 100 via the bass diaphragm 175.

Visible within the interior cavity of the speaker 100 is a circuit board 210, which is some embodiments may by multiple circuit boards rather than a single board. The circuit board 210 can include one or more of the circuits/components needed to provide the various functional features of the speaker 100. For example, the circuit board 210 may include contacts for the control buttons 135 accessible from outside of the top panel 105, as well as the lights, such as LEDs, providing the battery charge indicators 140 displaying the charge state of the battery 220 held within the interior of the speaker 100. A wiring harness 215 is also provided, which electrically couples various input/outputs of processors and other components on the circuit board 210 to components of the speaker 100. For example, drivers of the front-facing speakers 185 may be electrically coupled to the circuit board 210 for driving the speakers 185, as well as electrically coupling the power supplied from the battery 220 to power the circuit board 210 and other components of the speaker 100. Additionally, the charging port 225, which may include its own dedicated circuit board, as illustrated, is electrically coupled to the circuit board 210 via the wiring harness 220.

Included on the circuit board 210 may also be the active crossover circuitry for the speaker 100. Specifically, wireless speakers such as one constructed as disclosed herein typically include an onboard amplifier(s) because the wireless signals transmitted from the source device (e.g., a mobile phone) are not powerful enough to drive the speaker 185 drivers. A passive crossover uses a combination of resistors, inductors and capacitors combined to form a filter network placed between a power amplifier and speaker drivers to divide the amplifier's signal into the necessary frequency bands before being delivered to the individual speaker 185 drivers. However, since the amplifier circuitry is included on the circuit board 210 of the wireless speaker 100, an active crossover circuit is also beneficially employed on the circuit board 210. An active crossover is a filter circuit that divides the signal into individual frequency bands before power amplification, thus requiring at least one power amplifier for each frequency band on the circuit board 210.

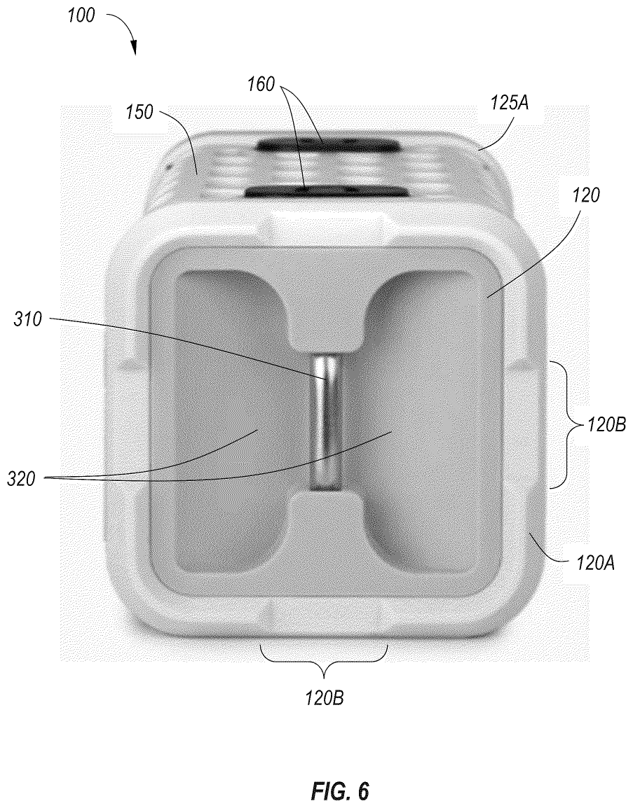

Looking now at FIG. 6, illustrated is a perspective bottom view of the speaker 100 illustrated in FIGS. 1-5. From this bottom view, the back panel 150, magnetic mounts 160, and base 120 may still be seen. The base bumper 120A and top bumper 125A may also again be seen. Also now visible is the tie down bar 310 held within the base 120, and usable to secure the speaker 100 to a surface in the standing position. While in this illustrated embodiment, portions of the base 120 are shown molded around ends of the tie down bar 310 to secure it in place, in other embodiments the tie down bar 310 may be fastened or adhered to the base 120. To prevent corrosion, the tie down bar 310 may be formed of stainless steel or other non-corroding material, while the base 120 is formed of the rigid plastic discussed above.

So that the base 120 of the speaker 100 maintains a substantially flat overall standing surface, a recess 320 is inwardly formed into the rigid material of the base 120 to permit passage of a fastening device, such as a strap, to pass between the base 120 and the tie down bar 310. In exemplary embodiments, the recess 320 is a tapered recess 320 that starts at the outermost surface of the base 120 on one side, tapers inwardly to a maximum depth under the tie down bar 310, and then tapers back towards the outermost surface of the base 120 on the opposite side.

Also visible in FIG. 6 are indentations 120B formed on several bottom edges of the base bumper 120A. These indentations 120B provide multiple features for speakers as disclosed herein. For example, the indentations 120B on the opposing sides of the tie down bar 310, which are formed to have a width substantially equal to the exposed width of the tie down bar 310, provide passages for a tie down strap to pass through when the speaker 100 is strapped to a surface. This advantageously allows the base bumper 120A to sit evenly and flush against the mounting surface even when strap is present. As discussed above, the soft, resilient material of the base bumper 120A prevents vibrational distortion when the speaker 100 is used. Additionally, these two indentations 120B, alone with indentations 120B formed on the other two bottom edges of the base bumper 120A, provides passageways in multiple directions for water or debris to pass under the speaker 100 when simply standing on or being strapped to a surface so as to prevent the speaker 100 from being moved by such passing water, etc.

### Sample Speaker Testing Results

The strength of portable speakers designed and constructed in accordance with the disclosed principles has been tested and proven through various tests. For example, sample speakers were subjected to longevity testing under high heat. Specifically, the speakers were run for 168 hours under a temperature of 35° C.±10° C. Functionality was tested every 24 hours, and full functionality was verified through the entire 168 hours.

In another test, sample speakers were subjected to extreme high temperature/high humidity one-half of a 12 hour cycle, and then extreme low temperature/low humidity for the second half of the 12 hour cycle, for 72 hours total. Specifically, the high temperature/high humidity was raised to 55° C. at 95% relative humidity, and then the temperature was decreased to −20° C. at 10% relative humidity for each 12 hour cycle. At the end of the 72 hours, after 6 cycles, full functionality was verified throughout and after the entire 72 hours.

In another extreme high/low temperature test, sample speakers were subject to an initial temperature of 20° C., then decreasing the temperature to 0° C. by 1° C./min. The samples were held at 0° C. for 4 hours, then the temperature was increased to 60° C. by 1° C./min. The samples were held at 60° C. for 4 hours, and then the temperature was decreased to 20° C. by 1° C./min where the samples were held at 20° C. for 2 hours. This temperature cycling was then repeated for 96 hours, and afterwards the samples had full functionality verified.

Another test of sample speakers was subjecting them to extreme humidity for long periods of time. Specifically, the speakers were held at 40° C.±3° C. at 95% humidity for 96 hours. Afterwards the sample speakers had full functionality verified.

Another test was an electrostatic discharge test to determine exemplary speakers' resistance to damage from electrostatic discharges from human touch or other sources having a built up static charge. Testing involved touching the samples at various locations, especially any metal or electroplated parts. After testing, all electrical components (e.g., ICs, transistors, etc.) all demonstrated full functionality.

In yet another test, sample speakers were dropped to determine the effect of impacts that are likely to occur during rough handling. Specifically, the samples were dropped from a height of 2.0 m onto a concrete floor 3 times, with each drop being once on a corner, once on an edge, and once on one of the front, back, or side surfaces of the sample. After the 3 drops, the samples were visually inspected for external physical damage, as well as inspected to determine if any internal components were damaged or jarred loose. In each test, the samples showed no signs of critical exterior damage beyond visible scuffs, nor any signs of internal component damage or loosening.

Samples speakers as disclosed herein were also subjected to vibration testing to test of the dynamic-mechanical robustness of such speakers during transportation or in typical use. Specifically, the samples were subjected to vibration equipment imparting random vibrations at 5-500 Hz 3G RMS for 1 hour per each X, Y, and Z axis or based on the ICE 60068-2-6-2007 requirement known in the art. During such testing, the loosening or losing of any internal or external component is considered a failure. However, afterwards the samples showed no signs of loosened or lost exterior or interior components.

Another test sample speakers were subject to was a rust test using salt spray. Specifically, the test involved spraying an NaCl solution (5%) at 35° C.±2° C. at 85% humidity, with a pH of the solution between 6.5 pH and 7.2 pH. After testing, the samples showed no signs of corrosion or other damage.

Similarly, sample speakers were tested for ultraviolet radiation resistance. Specifically, samples were subjected to 1120 W/m² light for 96 hours. After testing, the samples showed no visible signs of fading, cosmetic defects, or other visible damage.

In another test, sample speakers were subjected to a waterproof test. Specifically, the sample speakers underwent an industry standard IPX7 test. Moreover, these tests were performed with the cover discussed herein enclosing the charging port left open. After testing, the sample speakers had full functionality verified without any water entering their housings. Additionally, the samples did not show any visible signs of damage.

While this disclosure has been particularly shown and described with reference to preferred embodiments, it will be understood by those skilled in the pertinent field art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

What is claimed is:

1. A portable wireless speaker, comprising:
an inner structure defining a watertight hollow cavity within the inner structure;
at least two speaker drivers mounted at least partially within the hollow cavity, each speaker driver facing a first direction and having parallel centerlines;
at least one bass diaphragm mounted at least partially within the hollow cavity, and having a centerline between the centerlines of the at least two speaker drivers, the bass diaphragm facing a second direction oriented substantially 180 degrees from the first direction such that low-end frequency sounds waves emanating from a rear of the at least two speaker drivers are permitted exit from the hollow cavity via the bass diaphragm;
control circuitry having a wireless interface module receiving audio media from a wireless source, the control circuitry configured to drive the at least two speaker drivers to output the received audio media and to receive control inputs via a plurality of control buttons; and
a power source providing power to components of the speaker.

2. The portable wireless speaker of claim 1, wherein exteriors of the at least two speaker drivers are positioned below an exterior surface of the inner structure, said position preventing contact to the at least two speaker drivers from lateral forces against the inner structure.

3. The portable wireless speaker of claim 2, further comprising an impact-resistant speaker cover having a plurality of apertures mounted to the exterior of the inner structure and over the at least two speaker drivers.

4. The portable wireless speaker of claim 3, further comprising a rigid grille mounted to an interior surface of the speaker cover.

5. The portable wireless speaker of claim 1, wherein an exterior of the at least one bass diaphragm is positioned below an exterior surface of the inner structure, said position preventing contact to the at least one bass diaphragm from lateral forces against the inner structure.

6. The portable wireless speaker of claim 5, further comprising an impact-resistant speaker cover mounted to the exterior of the inner structure and over the at least one bass diaphragm.

7. The portable wireless speaker of claim 1, further comprising a watertight seal between the at least two speaker drivers and the inner structure, and the at least one bass diaphragm and the inner structure.

8. The portable wireless speaker of claim 1, further comprising a detachable handle removably attached to a top of the inner structure.

9. The portable wireless speaker of claim 1, further comprising a base and a top removably attached to respective opposing ends of the inner structure, each of the base and top comprising an impact resistant material.

10. The portable wireless speaker of claim 1, further comprising one or more magnetic mounts formed at least partially through the inner structure, the one or more magnetic mounts having a combined magnetic field at least as strong as an overall weight of the speaker, a seal provided between each of the one or more magnetic mounts and the inner structure.

11. The portable wireless speaker of claim 1, further comprising a seal provided between each of the plurality of control buttons and the inner structure.

12. The portable wireless speaker of claim 1, wherein the power source comprises at least one rechargeable battery.

13. A portable wireless speaker, comprising:
an inner structure defining a watertight hollow cavity within the inner structure;
at least two speaker drivers mounted at least partially within the hollow cavity, each speaker driver facing a first direction and having parallel centerlines, and wherein exteriors of the at least two speaker drivers are positioned below an exterior surface of the inner structure;
at least one bass diaphragm mounted at least partially within the hollow cavity, and having a centerline between the centerlines of the at least two speaker drivers, the bass diaphragm facing a second direction oriented substantially 180 degrees from the first direction such that low-end frequency sounds waves emanating from a rear of the at least two speaker drivers are permitted exit from the hollow cavity via the bass diaphragm, and wherein an exterior of the at least one bass diaphragm is positioned below an exterior surface of the inner structure;
control circuitry having a wireless interface module receiving audio media from a wireless source, the control circuitry configured to drive the at least two speaker drivers to output the received audio media and to receive control inputs via a plurality of control buttons; and
a rechargeable power source providing power to components of the speaker.

14. The portable wireless speaker of claim 13, further comprising:
an impact-resistant speaker cover having a plurality of apertures mounted to the exterior of the inner structure and over the at least two speaker drivers; and
a rigid grille mounted to an interior surface of the speaker cover.

15. The portable wireless speaker of claim 13, further comprising an impact-resistant speaker cover mounted to the exterior of the inner structure and over the at least one bass diaphragm.

16. The portable wireless speaker of claim 13, further comprising a watertight seal between the at least two speaker drivers and the inner structure and the at least one bass diaphragm and the inner structure.

17. The portable wireless speaker of claim 13, further comprising a detachable handle removably attached to a top of the inner structure.

18. The portable wireless speaker of claim 13, further comprising a base and a top removably attached to respective opposing ends of the inner structure, each of the base and top comprising an impact resistant material.

19. The portable wireless speaker of claim 13, further comprising one or more magnetic mounts formed at least partially through the inner structure, the one or more magnetic mounts having a combined magnetic field at least as strong as an overall weight of the speaker, a seal provided between each of the one or more magnetic mounts and the inner structure.

20. The portable wireless speaker of claim 13, further comprising a seal provided between each of the plurality of control buttons and the inner structure.
